(19) United States
(12) Patent Application Publication
(10) Pub. No.: US 2003/0038600 A1
(43) Pub. Date: Feb. 27, 2003

(54) Electron-emitting device and field emission display using the same

(75) Inventors: Yukihisa Takeuchi, Nagoya-City (JP); Tsutomu Nanataki, Nagoya-City (JP); Iwao Ohwada, Nagoya-City (JP); Tomoya Horiuchi, Nagoya-City (JP)

Correspondence Address: BURR & BROWN, PO BOX 7068, SYRACUSE, NY, 13261-7068, US

(73) Assignee: NGK Insulators, Ltd.

(21) Appl. No.: 10/206,409

(22) Filed: Jul. 26, 2002

Related U.S. Application Data
(63) Continuation-in-part of application No. 10/027,232, filed on Dec. 20, 2001.

(30) Foreign Application Priority Data
Dec. 22, 2000 (JP) 2000-390,299

(51) Int. Cl. G09G 3/10

(52) U.S. Cl. 315/169.3

(57) ABSTRACT

An electron-emitting element includes an electric field applying portion composed of a dielectric, a first electrode formed on one surface of the electric field applying portion, and a second electrode being formed on the surface and forming a slit in cooperation with the first electrode, and is formed on a substrate.

### TECHNICAL FIELD

The present invention relates to an electron-emitting element and a field emission display using the same.

### BACKGROUND ART

Such an electron-emitting element has a driving electrode and an earth electrode, and is applied to various applications such as an field emission display (FED) and back light. In case of applying to an FED, a plurality of electron-emitting elements are two dimensionally arrange in two dimensions and a plurality of phosphors being opposite to these electron-emitting elements are arranged at a certain space to each other.

However, since a conventional electron-emitting element is not good in straight advancing ability, namely, in the degree of the straight advancement of electron emitted from the elctron-emitting element to specified objects (phosphors for example), and in order to hold a desired current density by emitted electrons, it is necessary to apply a comparatively high voltage to the electron-emitting element.

And in case of applying the conventional electron-emitting element to the FED, since straight advancing ability of the conventional electron-emitting element is not good, the crosstalk is relatively large, namely, there is a high probability that an emitted electron strikes on a phosphor adjacent to a targeted phosphor. As a result, it is difficult to make the pitch between the phosphors narrow and it is necessary to provide a grid in order to prevent an electron from hitting on an adjacent phosphor.

It is an object of the present invention is to provide an electron-emitting element having a good straight advancing ability of emitted electrons and a field emission display using the same.

It is another object of the present invention is to provide an electron-emitting element realizing an electron emission with a high current density at a comparatively low vacuum and a remarkable low driving voltage and a field emission display using the same.

### DISCLOSURE OF THE INVENTION

There is provided an electron-emitting element comprising;

an electric field applying portion composed of dielectric,

a first electrode formed on one surface of this electric field applying portion,

a second electrode formed on one surface of the electric field applying portion and forming a slit in cooperation with the first electrode.

According to the present invention, electrons are emitted from the electric field applying portion by applying a pulse voltage to the first or second electrode. By composing the electric field applying portion by the dielectric, it is possible to obtain a good straight advancing ability that cannot be achieved by the conventional electron-emitting element. As a result, a voltage to be applied to the electron-emitting element needed to hold a desired current density is remarkably lower than that of the conventional electron-emitting element, and the energy consumption is greatly reduced. Since the first and second electrodes can be formed on the electric field applying portion by means of a thick film printing method, the electron-emitting element according to the present invention is preferable from the viewpoint of durability and cost reduction.

In order to reduce the voltage to be applied to the electron-emitting element furthermore, it is preferable to apply a conductive coating portion to the first and second electrodes and the slit. In this case, by the application of the conductive coating portion, there is remarkable reduction of the probability to damage the first and second electrodes caused by collision between electrons and ions or by generation of heat.

More preferably, the electron-emitting element further comprises a first conductive coating portion provided on the first electrode; and

a second conductive coating portion provided on the second electrode;

wherein, there is non-contact condition between the first conductive coating portion and the second conductive coating portion. In this case, it is not necessary to provide a capacitor for cutting off a direct current because there is no resistor in an equivalent between the first electrode and the second electrode, and thus it is possible to reduce a voltage to be applied to the electron-emitting element because it is not necessary to drive the electron-emitting element with a high voltage. In this case, also, by the application of the first and the second conductive coating portions, there is remarkable reduction of the probability to damage the first and second electrodes caused by collision between electrons and ions or by generation of heat.

A portion with a high resistance may be provided on the slit, the portion having a higher resistance than those of the first and the second conducing coating portions and being in contact with the first and the second conducting coating portions electrically. In this case, the portion with a high resistance has a higher voltage than those of the first and the second conductive coating portions when applying the voltage to the electron-emitting element, and thus the degree of the concentration of the electric field in the portion with a high resistance, or the slit is improved. As a result, it is possible to emit electrons at a lower applied voltage compared with the case of having no portion with a high resistance, reduce the power consumption of the electron-emitting element and achieve the cost reduction of the electron-emitting element because of miniaturizing the circuit of the electron-emitting element and omitting parts for a high voltage from the electron-emitting element.

In order to perform a certain electron emission, it is preferable to further comprise a third electrode arranged at a certain space to the first and second electrodes, and to make the space between the first and second electrodes and the third electrode vacuum.

There is provided another electron-emitting element comprising:

an electric field applying portion composed of at least one of a piezoelectric material, an electrostrictive material and an antiferroelectric material;

a first electrode formed on one surface of this electric field applying portion; and

a second electrode formed on the one surface of the electric field applying portion, and forming a slit in cooperation with the first electrode.

According to the present invention, the electric field applying portion also acts as an actuator and may be bent and displayed when a pulse voltage is applied to the first or second electrode. As a result, the straight advancing ability of the electron-emitting element is more improved.

In order to reduce the voltage to be applied to the electron-emitting element further more, it is preferable to apply the conductive coating portion to the first and second electrodes and the slit. In this case, by the application of the conductive coating portion, there is remarkable reduction of the probability to damage the first and second electrodes caused by collision between electrons and ions or by generation of heat.

More preferably, the electron-emitting element further comprises a first conductive coating portion provided on the first electrode; and

a second conductive coating portion provided on the second electrode;

wherein, there is non-contact condition between the first conductive coating portion and the second conductive coating portion. In this case, it is not necessary to provide a capacitor for cutting off a direct current because there is no resistor in an equivalent between the first electrode and the second electrode, and thus it is possible to reduce a voltage to be applied to the electron-emitting element because it is not necessary to drive the electron-emitting element with a high voltage. In this case, also, by the application of the first and the second conductive coating portions, there is remarkable reduction of the probability to damage the first and second electrodes caused by collision between electrons and ions or by generation of heat.

A portion with a high resistance way be provided on the slit, the portion having a higher resistance than those of the first and the second conducting coating portions and being in contact with the first and the second conducting coating portions electrically. In this case, the portion with a high resistance has a higher voltage than those of the first and the second conductive coating portions when applying the voltage to the electron-emitting element, and thus the degree of the concentration of the electric field in the portion with a high resistance, or the slit is improved. As a result, it is possible to emit electrons at a lower applied voltage compared with the case of having no portion with a high resistance, reduce the power consumption of the electron-emitting element and achieve the cost reduction of the electron-emitting element because of miniaturizing the circuit of the electron-emitting element and omitting parts for a high voltage from the electron-emitting element.

In this case, also, in order to perform a certain electron emission, it is preferable to further comprises a third electrode being arranged at a certain space to the first and second electrodes and to make the space between the first and second electrodes and the third electrode vacuum. At this time, the electric field applying portion also acts as the actuator, and makes it possible to control the amount of emitted electrons by the displacement motion of the electric field applying portion.

Preferably, the electron-emitting element further has a voltage source for applying a direct offset voltage to the third electrode, and a resistor arranged in series between the voltage source and the third electrode. Thereby, a desired current density can be easily achieved, and short-circuit between the third electrode and the first and second electrodes is prevented.

For example, a pulse voltage is applied to the first electrode, and a direct offset voltage is applied to the second electrode.

Preferably, the electron-emitting element further has a capacitor arranged in series between the first electrode and a voltage signal source. Thereby, a voltage can be applied between the first electrode and the second electrode only until the capacitor is charged up, and as a result, the breakage caused by the short-circuit between the first and second electrodes is prevented.

In case of further having a fourth electrode being formed on the other surface of the electric field applying portion and opposite to the first electrode, since the electric field applying portion between the first electrode and the third electrode acts as a capacitor, the breakage caused by the short-circuit between the first and second electrodes is prevented. In this case, for example, a pulse voltage is applied to the fourth electrode and a direct offset voltage is applied to the second electrode.

It may further have a resistor arranged in series between the second electrode and the direct offset voltage source. In this case, a current to be flowed by discharging from the first electrode to the second electrode is suppressed by the resistor, and breakage to be caused by short-circuit between the first and second electrodes is prevented.

In order to achieve sharp reduction of the voltage to be applied, it is preferable to have the relative dielectric constant of the electric field applying portion not less than 1000 and/or the width of said slit not more than 500 μm.

In order to perform a certain electron emission, it is preferable for at least one of the first and second electrodes to have an angular part with an acute angle and/or for the first electrode and the second electrode to have carbon nanotubes, in other words, the particle or the flocculation body of the particles which includes carbon material having six-fold-ring structure.

There is provided a field emission display comprising:

a plurality of electron-emitting elements arranged in two dimensions; and

a plurality of phosphor being arranged at a certain space to each of these electron-emitting elements, each of said electron-emitting elements having:

an electric field applying portion composed of a dielectric;

a first electrode formed on one surface of this electric field applying portion; and

a second electrode formed on the surface of the electric field applying portion, and forming a slit in cooperation with the first electrode.

Since a field emission display according to the present invention is excellent in the straight advancing ability of the electron-emitting element, it is smaller in crosstalk in comparison with a display comprising conventional electron-emitting elements, the pitch between phosphors can be made more narrow, and it is not necessary to provide a grid in order to prevent electrons from striking on phosphors adjacent to the targeted phosphors. As a result, a field emission display according to the present invention is preferable from the viewpoint of improvement in resolution, downsizing and cost reduction of a display device. Since the emission of electrons can be performed even in case that the degree of vacuum inside a field emission display is comparatively low, it is possible to emit electrons even when the degree of vacuum inside the display is lowered by a cause such as a phosphor excitation and the like. Since a conventional field emission display needs to hold a comparatively large vacuum space as a margin for maintaining the emission of electrons, it has been difficult to make the display thin-sized. On the other hand, since the present invention does not need to hold a large vacuum space in advance in order to keep the emission of electrons against drop of the degree of vacuum, it is possible to make the display thin-sized.

In order to reduce the voltage to be applied to the electron-emitting element further more, it is preferable to apply the conductive coating portion to the first and second electrodes and the slit. In this case, by the application of the conductive coating portion, there is remarkable reduction of the probability to damage the first and second electrodes caused by collision between electrons and ions or by generation of heat.

More preferably, the electron-emitting element further comprises a first conductive coating portion provided on the first electrode; and

a second conductive coating portion provided on the second electrode;

wherein, there is non-contact condition between the first conductive coating portion and the second conductive coating portion. In this case, it is not necessary to provide a capacitor for cutting off a direct current because there is no resistor in an equivalent between the first electrode and the second electrode, and thus it is possible to reduce a voltage to be applied to the electron-emitting element because it is not necessary to drive the electron-emitting element with a high voltage. In this case, also, by the application of the first and the second conductive coating portions, there is remarkable reduction of the probability to damage the first and second electrodes caused by collision between electrons and ions or by generation of heat.

A portion with a high resistance may be provided on the slit, the portion having a higher resistance than those of the first and the second conducting coating portions and being in contact with the first and the second conducting coating portions electrically. In this case, the portion with a high resistance has a higher voltage than those of the first and the second conductive coating portions when applying the voltage to the electron-emitting element, and thus the degree of the concentration of the electric field in the portion with a high resistance, or the slit is improved. As a result, it is possible to emit electrons at a lower applied voltage compared with the case of having no portion with a high resistance, reduce the power consumption of the electron-emitting element and achieve the cost reduction of the electron-emitting element because of miniaturizing the circuit of the electron-emitting element and omitting parts for a high voltage from the electron-emitting element.

In order to perform a certain electron emission, it is preferable to further have a third electrode arranged at a certain space to the first and second electrodes and make the space between the first and second electrodes and the third electrode vacuum.

There is provided another field emission display comprising:

a plurality of electron-emitting elements arranged in two dimensions; and

a plurality of phosphors arranged at a certain space to each of these electron-emitting elements, each of the electron-emitting elements having:

an electric field applying portion composed of at least one of a dielectric material, an electrostrictive material and an antiferroelectric material;

a first electrode formed on one surface of this electric field applying portion; and

a second electrode formed on the surface of the electric field applying portion, and forming a slit in cooperation with the first electrode.

Since a field emission display according to the present invention is excellent in the straight advancing ability of the electron-emitting element, it is more preferable from the viewpoint of miniaturizing and cost reduction of a display device.

In order to reduce the voltage to be applied to the electron-emitting element furthermore, it is preferable to apply the conductive coating portion to the first and second electrodes and the slit. In this case, by the application of the conductive coating portion, there is remarkable reduction of the probability to damage the first and second electrodes caused by collision between electrons and ions or by generation of heat.

More preferably, the electron-emitting element further comprised a first conductive coating portion provided on the first electrode; and

a second conductive coating portion provided on the second electrode;

wherein, there is non-contact condition between the first conductive coating portion and the second conductive coating portion. In this case, it is not necessary to provide a capacitor for cutting off a direct current because there is no resistor in an equivalent between the first electrode and the second electrode, and thus it is possible to reduce a voltage to be applied to the electron-emitting element because it is not necessary to drive the electron-emitting element with a high voltage. In this case, also, by the application of the first and the second conductive coating portions, there is remarkable reduction of the probability in damage the first and second electrodes caused by collision between electrons and ions or by generation of heat.

A portion with a high resistance may be provided on the slit, the portion having a higher resistance than those of the first and the second conducting coating portions and being in contact with the first and the second conducting coating portions electrically. In this case, the portion with a high resistance has a higher voltage than those of the first and the second conductive coating portions when applying the voltage to the electron-emitting element, and thus the degree of the concentration of the electric field in the portion with a high resistance, or the slit is improved. As a result, it is possible to emit electrons at a lower applied voltage compared with the case of having no portion with a high resistance, reduce the power consumption of the electron-emitting element and make the cost down because of miniaturizing the circuit of the electron-emitting element and omitting parts for a high voltage from the electron-emitting element.

In this case, also, in order to perform a certain electron emission, it is preferable to further have a third electrode arranged at a certain space to the first and second electrodes and make the space between the first and second electrodes and the third electrode vacuum. At this time, the electric field applying portion also acts as an actuator and can control the amount of emitted electrons by the displacement motion of the electric field applying portion.

Preferably, the electron-emitting element further has a voltage source for applying a direct offset voltage to the third electrode and a resistor arranged in series between this voltage source and the third electrode. Thereby, a desired current density, namely, a desired amount of luminescence of phosphors can be easily achieved, and the short-circuit between the third electrode and the first and second electrodes is prevented.

For example, a pulse voltage is applied to the first electrode and a direct offset voltage is applied to the second electrode.

Preferably, the electron-emitting element further has a capacitor arranged in series between the first electrode and the voltage signal source. Thereby, the breakage to be caused by the short-circuit between the first and second electrodes is prevented.

Also, when the electron-emitting element further has a fourth electrode formed on the other surface of the electric field applying portion and facing the first electrode, the breakage to be caused by the short-circuit between the first and second electrodes. In this case, for example, a pulse voltage is applied to the fourth electrode and a direct offset voltage is applied to the second electrode.

In this case that the electron-emitting element further has a resistor arranged in series between the second electrode and the direct offset voltage source, the breakage to he caused by the short-circuit between the first and second electrodes is prevented.

In order to achieve a sharp reduction of the voltage to be applied, it is preferable to have the relative dielectric constant of the electric field applying portion not less than 1000 and/or the width of the slit not more than 500 μm.

In order to perform a certain electron emission, it is preferable for at least one of the first and second electrodes to have an angular part with an acute angle and/or for the first and second electrodes to have carbon nanotubes.

A field emission display according to the present invention further comprises a substrate having a plurality of electron-emitting elements arranged in two-dimensions and formed into one body with it.

### BRIEF DESCRIPTION OF THE DRAWINGS

FIG. 1 is a diagram showing a first embodiment of the electron-emitting element according to the present invention.

FIG. 2 is a diagram showing a second embodiment of the electron emitting element according to the present invention.

FIG. 3 is a diagram showing a third embodiment of the electron-emitting element according to the present invention.

FIG. 4 is a diagram showing a fourth embodiment of the electron-emitting element according to the present invention.

FIG. 5 is a diagram showing a fifth embodiment of the electron-emitting element according to the present invention.

FIG. 6 is a diagram showing a sixth embodiment of the electron-emitting element according to the present invention.

FIG. 7 is a diagram for explaining the operation of the electron-emitting element according to the present invention.

FIG. 8 is a diagram for explaining the operation of the other electron-emitting element according to the present invention.

FIG. 9 is a diagram showing an embodiment of the FED according to the present invention.

FIG. 10 is a diagram showing the relation between the relative dielectric constant of the electron-emitting element according to the present invention and the applied voltage to the electron-emitting element.

FIG. 11 is a diagram for explaining FIG. 10.

FIG. 12 is a diagram showing the relation between the slit width of the electron-emitting element according to the present invention and an applied voltage to the electron-emitting element.

FIG. 13 is a diagram showing a seventh embodiment of the electron-emitting element according to the present invention.

FIG. 14 is a diagram for explaining the operation of the electron-emitting element of FIG. 13.

FIG. 15 is a diagram showing an eighth embodiment of the electron-emitting element according to the present invention.

FIG. 16 is a diagram for explaining the operation of the electron-emitting element of FIG. 15.

FIG. 17 is a diagram for explaining the effect of the electron-emitting element.

FIG. 18 is a diagram showing a ninth embodiment of the electron-emitting element according to the present invention.

FIG. 19 is a diagram showing a variation of the electron-emitting element of FIG. 18.

FIG. 20 is a diagram showing a tenth embodiment of the electron-emitting element according to the present invention.

FIG. 21 is a diagram showing a eleventh embodiment of the electron-emitting element according to the present invention.

FIG. 22 is a diagram for explaining the operation of the electron-emitting element of FIG. 21.

### BEST MODE FOR CARRYING OUT THE INVENTION

Embodiments of the electron-emitting element and the field emission display using the same will be explained with reference to the drawings.

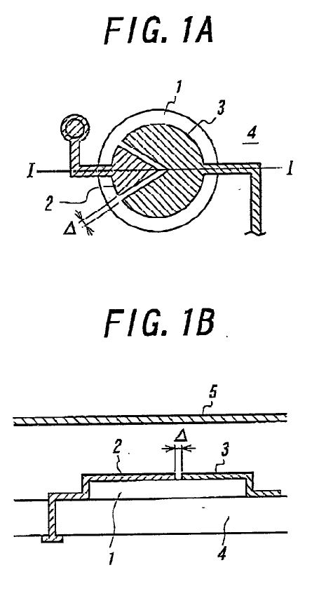

FIG. 1A is a top view of a first embodiment of the electron-emitting element according to the present invention, and FIG. 1B is a sectional view taken along line I-I. This electron-emitting element has an electric field applying portion 1 composed of a dielectric, a driving electrode 2 as a first electrode formed on one surface of the electric field applying portion 1 and a common electrode 3 as a second electrode formed on the surface on which the driving electrode 2 is formed and forming a slit in cooperation with the driving electrode 2, and the electron-emitting element is formed on a substrate 4. Preferably, in order to capture emitted electrons well, this electron-emitting element further has an electron capturing electrode 5 as a third electrode arranged at a certain space to the one surface of the electric field applying portion 1, and keeps the space therebetween in a vacuum state. And in order to prevent breakage caused by short-circuit between the driving electrode 2 and the common electrode 3, a capacitor not illustrated is arranged in series between the driving electrode 2 and an not shown voltage signal source and/or an not shown resistor is arranged in series between the common electrode 3 and an not shown direct offset voltage source.

A dielectric being comparatively high, for example, not less than 1000 in relative dielectric constant is preferably adopted as a dielectric forming the electric field applying portion 1. As such a dielectric, there can be mentioned ceramic containing barium titanate, lead zirconate, magnesium lead niobate, nickel lead niobate, zinc lead niobate, manganese lead niobate, magnesium lead tantalate, nickel lead tantalate, antimony lead stannate, lead titanate, barium titanate, magnesium lead tungstate, cobalt lead niobate or the like, or an optional combination of these, and ceramic containing these compounds of 50 wt % or more as its main ingredients, and furthermore ceramic having an oxide of lanthanum, calcium, strontium, molybdenum, tungsten, barium, niobium, zinc, manganese, nickel or the like, or some combination of these or other compounds and the like properly added to said ceramic. For examples in case of a two-compound system nPMN-mPT (n and m are represented in molar ratio) of magnesium lead niobate (PMN) and lead titanate (PT), when the molar ratio of PMN is made large, its Curie point is lowered and its relative dielectric constant at a room temperature can be made large. Particularly, the condition of “n=0.85 to 1.0, m=1.0−n” makes preferably a relative dielectric constant of 3000 or more. For example, the condition of “n=0.91, m=0.09” gives a relative dielectric constant of 15,000 at a room temperature and the condition of “n=0.95, m=0.05” gives a relative dielectric constant of 20,000 at a room temperature. Next, in a three-component system of magnesium lead niobate (PMN), lead titanate (PT) and lead zirconate (PZ), it is preferable for the purpose of making the relative dielectric constant to make the composition of the three-component system close to the composition of the vicinity of the morphotropic phase boundary (MPB) between a tetragonal system and a pseudo-tetragonal system or between a tetragonal system and a rhombohedral system as a manner other than making the molar ratio of PMN be large. Particularly preferably, for example, the condition of “PMN:PT:PZ=0.375:0.375:0.25” provides the relative dielectric constant of 5,500 and the condition of “PMN:PT:PZ=0.5:0.375:0.125” provides the relative dielectric constant of 4,500. Further, it is preferable to improve the dielectric constant by mixing these dielectrics with such metal as platinum within a range where the insulation ability is secured. In this case, for example, the dielectric is mixed with platinum of 20% in weight.

In this embodiment, the driving electrode 2 has an angular part with an acute angle. A pulse voltage is applied to the driving electrode 2 from an not shown power source, and electrons are emitted mainly from the angular part. In order to perform a certain electron emission, the width Λ of the slit between the driving electrode 2 and the common electrode 3 is preferably not more than 500 μm. The driving electrode 2 is composed of a conductor with resistance to a high-temperature oxidizing atmosphere, for example, a single metal, an alloy, a mixture of an insulating ceramic and a single metal, a mixture of an insulating ceramic and an alloy or the like, and is preferably composed of a high-melting point precious metal such as platinum, palladium, rhodium, molybdenum or the like, or a material having such an alloy as silver—palladium, silver—platinum, platinum—palladium or the like as its main ingredient, or a cermet material of platinum and ceramic. More preferably, it is composed of only platinum or a material having a platinum-based alloy as its main ingredient. And as a material for electrodes, carbon-based or graphite-based materials, for example, a diamond thin film, a diamond-like carbon and a carbon nanotube are also preferably used. A certain material added to the electrode material is preferably 5 to 30 vol %.

The driving electrode 2 can be composed using the above-mentioned materials by an ordinary film forming method by means of various thick film forming methods such as screen printing, spraying, coating, dipping, application, electrophoresing and the like, or various thin film forming methods such as sputtering, ion beaming, vacuum deposition, ion plating, CVD, plating and the like, and is preferably made by these thick film forming methods.

In case of forming the driving electrode 2 by means of a thick film forming method, a thickness of driving electrode 2 is generally not more than 20 μm, and preferably not more than 5 μm.

A direct offset voltage is applied to the common electrode 3, and is led by the wiring passing through an not shown through hole from the reverse side of the substrate 4.

The common electrode 3 is formed by means of a material and method similar to those for the driving electrode 2, and preferably by means of the above-mentioned thick film forming methods. The width of the common electrode 3 also is generally not more than 20 μm and preferably not more than 5 μm.

Preferably, the substrate 4 is composed of an electrically insulating material in order to electrically separate a wire electrically connected to the driving electrode 2 and a wire electrically connected to the common electrode 3 from each other.

Therefore, the substrate 4 can be composed of a material like an enameled material obtained by coating the surface of a high heat-resistant metal with a ceramic material such as glass and the like, and is optimally composed of ceramic.

As a ceramic material to form the substrate 4, for example, stabilized zirconium oxide, aluminum oxide, magnesium oxide, titanium oxide, spinel, mullite, aluminum nitride, silicon nitride, glass, a mixture of these and the like can be used. Among them, particularly aluminum oxide and stabilized zirconium oxide are preferable from the viewpoint of strength and rigidity. Stabilized zirconium oxide is particularly preferable in that it is comparatively high in mechanical strength, comparatively high in toughness an comparatively small in chemical reaction to the driving electrode 2 and the common electrode 3. The stabilized zirconium oxide includes stabilized zirconium oxide and partially stabilized zirconium oxide. Since the stabilized zirconium oxide takes a crystal structure such as a cubic system, it undergoes no phase transition.

On the other hand, it is probable that the zirconium oxide undergoes a phase transition between a monoclinic system and a tetragonal system and has a crack generated at the time of such a phase transition. The stabilized zirconium oxide contains a stabilizer such as calcium oxide, magnesium oxide, yttrium oxide, scandium oxide, ytterbium oxide, cerium oxide, rare metal oxide and the like of 1 to 30 mol %. It is preferable for a stabilizer to contain yttrium oxide in order to improve the substrate 4 in mechanical strength. In this case, it contains yttrium of preferably 1.5 to 6 mol %, more preferably 2 to 4 mol %, and preferably further contains aluminum oxide of 1 to 5 mol %.

And its crystal phase can be made into a mixed phase of “cubic system+monoclinic system”, a mixed phase of “tetragonal system+monoclinic system”, a mixed phase of “cubic system|tetragonal system|monoclinic system” or the like, and among them particularly the crystal phase having a tetragonal system or a mixed phase of “tetragonal system+cubic system” as its main crystal phase is optimal from the viewpoint of strength, toughness and durability.

In case of composing the substrate 4 of ceramic, comparatively many crystal particles form the substrate 4, and in order to improve the substrate 4 in mechanical strength, the average particle diameter of the crystal particles is be preferably 0.05 to 2 μm, and more preferably 0.1 to 1 μ.

The electric field applying portion 1, the driving electrode 2 and the common electrode 3 can be formed into one body together with the substrate 4 by applying heat treatment to the substrate 4, namely, by baking the substrate 4 each time forming one of them respectively, or these electric field applying portion 1, the driving electrode 2 and the common electrode 3 are formed on the substrate 4 and thereafter are heat-treated, namely, are baked at the same time and thereby they are formed into one body together with the substrate 4 at the same time.

Depending upon a method of forming the driving electrode 2 and common electrode 3, any heat treatment, namely, baking for unification of them may not be needed.

A heat treatment temperature, namely, a baking temperature for forming the electric field applying portion 1, the driving electrode 2 and the common electrode 3 into one body together with the substrate 4 takes a temperature range of generally 500 to 1,400° C., and preferably 1,000 to 1,400° C. In order to keep stable the composition of the electric field applying portion 1 at a high temperature in case of applying heat treatment to the film-shaped voltage applying portion 1, it is preferable to perform heat treatment, namely baking as controlling the vapor source and the atmosphere of the electric field applying portion 1, and it is preferable to adopt a technique of baking as preventing the surface of the electric field applying portion 1 from being exposed directly to the baking atmosphere by covering the electric field applying portion 1 with a proper member. In this case a material similar to the substrate 4 is used as the covering member.

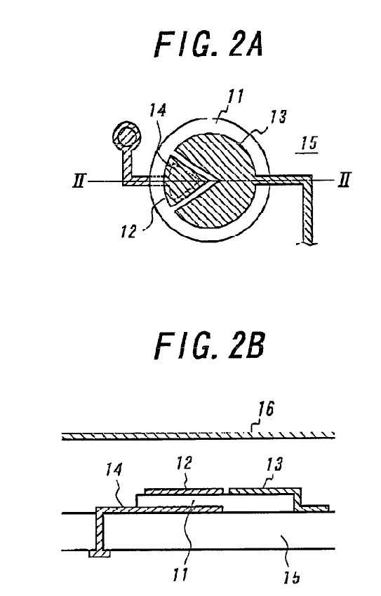

FIG. 2A is a top view of a second embodiment of the electron-emitting element according to the present invention, and FIG. 2B is a sectional view taken along a line II-II of it. This electron-emitting element has an electric field applying portion 11, a driving electrode 12 and a common electrode 13 respectively corresponding to the electric field applying portion 1, the driving electrode 2 and the common electrode 3, and additionally to them, further has a driving terminal electrode 14 as a fourth electrode formed on the other surface of the electric field applying portion 11, and they are formed on a substrate 15. In this case, also, preferably in order to capture emitted electrons well, the electron-emitting element further has an electron capturing electrode 16 as a third electrode being arranged at a certain space to one surface of the electric field applying portion 11, and keeps the space therebetween in a vacuum state.

In this embodiment, since the electric field applying portion 11 between the driving electrode 12 and the driving terminal electrode 14 acts as a capacitor, it is not necessary to provide an additional capacitor in order to prevent breakage, caused by short-circuit between the driving electrode 12 and the common electrode 13. In this case, a pulse voltage is applied to the driving terminal electrode 14 and a direct offset voltage is applied to the common electrode 13.

The driving terminal electrode 14 is also formed by means of a similar material and technique to those for the driving electrode 12 and the common electrode 13, and preferably formed by means of one of the above-mentioned thick film forming methods. The thickness of the driving terminal electrode 14 is also generally not more than 20 μm, and preferably not more than 5 μm.

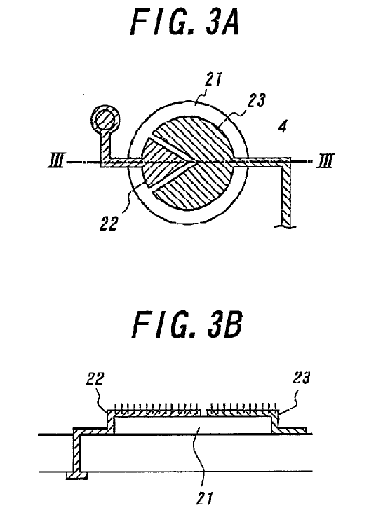

FIG. 3A is a top view of a third embodiment of the electron-emitting element according to the present invention, and FIG. 3B is a sectional view taken along a line III-III of it. In this embodiment, similarly to the first embodiment, a driving electrode 22 and a common electrode 23 are formed on one surface of an electric field applying portion 21, and a plurality of carbon nanotubes (CNT) are provided on the surfaces of these driving electrode 22 and common electrode 23, and thereby it is easy to emit electrons from the top of the CNT when applying a pulse voltage to the driving electrode 22 and applying a direct offset voltage to the common electrode 23.

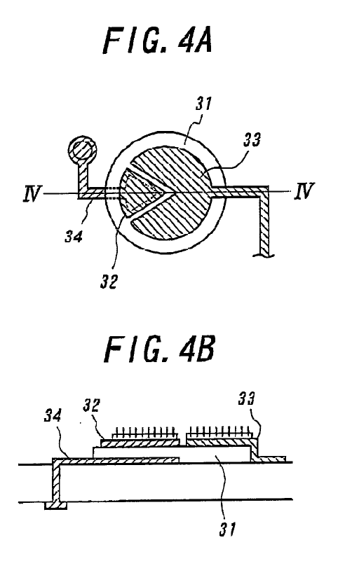

FIG. 4A is a top view of a fourth embodiment of the electron-emitting element according to the present invention, and FIG. 4B is a sectional view taken along a line IV-IV of it. In this embodiment, similarly to the second embodiment, a driving electrode 32 and a common electrode 33 are formed on one surface of an electric field applying portion 31, and a driving terminal electrode 34 is formed on the other surface of it, and a plurality of carbon nanotubes (CNT) are provided on the surfaces of these driving electrode 32 and common electrode 33, and thereby it is easy to emit electrons from the top of the CNT when applying a pulse voltage to the driving electrode 32 and applying a direct offset voltage to the common electrode 33.

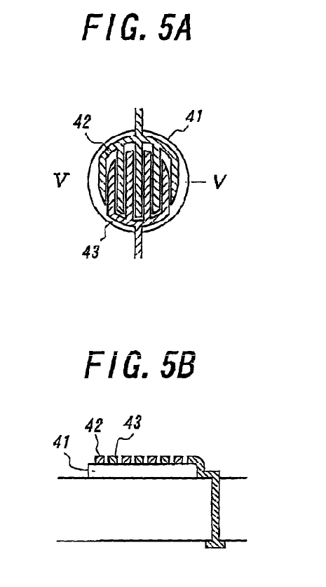

FIG. 5A is a top view of a fifth embodiment of the electron-emitting element according to the present invention, and FIG. 5B is a sectional view taken along a line V-V of it. In this embodiment, a driving electrode 42 and a common electrode 43 which are in the shape of the teeth of a comb are formed on one surface of an electric field applying portion 41. In this case, it is easy to emit electrons from the angular parts of those driving electrode 42 and common electrode 43.

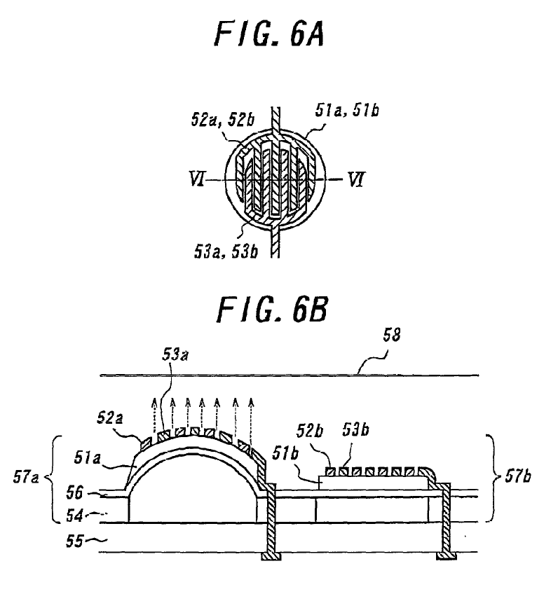

FIG. 6A is a top view of a sixth embodiment of the electron-emitting element according to the present invention, and FIG. 6B is a sectional view taken along line VI-VI of it. In this embodiment, the electron-emitting element has electric field applying portions 51a, 51b made of an antiferroelectric material, and driving electrodes 52a, 52b and common electrodes 53a, 53b which are in the shape of the teeth of a comb and are formed respectively on one-side surfaces of the electric field applying portions 51a, 51b.

The electron-emitting element is disposed on a sheet layer 56 provided through a spacer layer 54 on a substrate 55. Thereby, the electric field applying portions 51a, 51b, the driving electrodes 52a, 52b, the common electrodes 53a, 53b, the sheet layer 56 and the spacer layer 54 form actuators 57a, 57b, respectively.

As an antiferroelectric material for forming the electric field applying portions 51a, 51b, it is preferable to use a material having lead zirconate as its main ingredient, a material having a component consisting of lead zirconate and lead stannate as its main ingredient, a material obtained by adding lanthanum oxide to lead zirconate, or a material obtained by adding lead zirconate or lead niobate to a component consisting of lead zirconate and lead stannate. Particularly, in case of driving the electron-emitting element at a low voltage, it is preferable to use an antiferroelectric material containing a component consisting of lead zirconate and lead stannate. Its composition is as follows.

PB_{0.99}Nb_{0.002}[(ZrₓSn₁₋ₓ)_{1-y}Ti_{y}]_{0.98}O₃

And the antiferroelectric materials can be also made porous, and in this one it is preferable to make the porosity be not more than 30%.

The electric field applying portions 51a, 51b are preferably formed by means of one of the above-mentioned thick film forming methods, and a screen printing method is preferably in particular used by reason that it can perform inexpensively a fine printing. The thickness of the electric field applying portions 51a, 51b is made to be preferably 50 μm or less and more preferably 3 to 40 μm from the reason of obtaining a large displacement at a low operating voltage and the like.

By such a thick film forming technique, a film can be formed on the surface of the sheet layer 56 using paste or slurry having as its main ingredient antiferroelectric ceramic particles having the average particle diameter of 0.01 to 7 μm, preferably 0.05 to 5 μm, and a good element characteristic can be obtained.

An electrophoresis method can form a film in a high density under a high shape control, and has features as described in technical papers “DENKI KAGAKU (ELECTROCHEMISTRY) 53, No. 1 (1985), pp. 63-68 by Kazuo Anzai” and “First Study Meeting On Method For High Order Forming Of Ceramic By Electrophoresis, Collection of Papers (1998), pp. 5-6 and pp. 23-24”. Therefore, it is preferable to properly select and use a technique from various techniques in consideration of required accuracy, reliability and the like.

The sheet layer 56 is relatively thin and has a structure liable to receive vibration from an external stress. The sheet layer 56 is preferably composed of a high heat-resisting material. The reason is to prevent the sheet layer 56 from deteriorating in quality at least when forming the electric field applying portions 51a, 51b in case of using a structure directly supporting the sheet layer 56 without using a material being comparatively low in heat resistance such as an organic adhesive and the like at the time of joining a driving terminal electrode directly to the sheet layer 56 as shown in FIGS. 2 and 4. In case of forming the sheet layer 56 out of ceramic, it is formed in a similar manner to the substrate 4 in FIG. 1.

The spacer layer 54 is preferably formed out of ceramic, and it may be formed out of the same material as or a different material from a ceramic material forming the sheet layer 56. As such ceramic, in the same manner as a ceramic material for forming the sheet layer 56, for example, stabilized zirconium oxide, aluminum oxide, magnesium oxide, titanium oxide, spinel, mullite, aluminum nitride, silicon nitride, glass, a mixture of these, and the like can be used.

As ceramic materials different from ceramic materials forming the spacer layer 54, the substrate 55 and the sheet layer 56, a material having zirconium oxide as its main ingredient, a material having aluminum oxide as its main ingredient, a material having a mixture of these as its main ingredient and the like are preferably adopted. Among them, a material having zirconium oxide as its main ingredient is particularly preferable. Clay or the like may be added as a sintering adjuvant, but it is necessary to adjust the composition of such an adjuvaut so as not to contain excessively such an ingredient being liable to glass as silicon oxide, boron oxide and the like. The reason is that these materials liable to glass are advantageous from the viewpoint of joining with the electric field applying portions 51a, 51b, but they accelerate reaction with the electric field applying portions 51a, 51b, make it difficult for the electric field applying portions 51a, 51b to keep their specified composition, and as the result, causes the element characteristics to be deteriorated.

That is to say, it is preferably to limit silicon oxide and the like contained in the spacer layer 54, the substrate 55 and the sheet layer 56 to not more than 3% in weight preferably not more than 1%. Here, an ingredient occupying not less than 50% in weight is referred to as the main ingredient.

The spacer layer 54, the substrate 55 and the sheet layer 56 are preferably formed into a 3-layered laminate, and in this case, for example, simultaneous unification baking, joining the respective layers by glass or resin together with each other into one body or after-joining is performed. They can be also formed into a laminate having not less than four layers.

In case of forming the electric field applying portions 51a, 51b out of an antiferroelectric material like this embodiment, they become flat like the electric field applying portion 51b in a state where no electric field is applied, while they are bent and displaced in a convex shape like the electric field applying portion 51a when an electric field is applied to them. Since the space between the electron-emitting element and the electron capturing electrode 58 being opposite to it is made narrow by bending in such a convex shape, the straight advancing ability of electrons generated is more improved as shown by arrows. Therefore, it is possible to control the amount of emitted electrons to reach the electron capturing electrode 58 by means of this quantity of bending.

Next, the operation of the electron-emitting element according to the present invention is described.

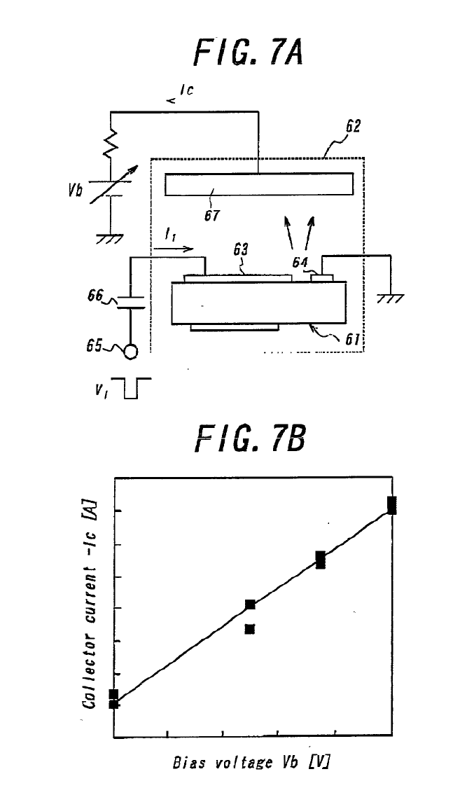

FIG. 7 is a diagram for explaining the operation of the electron-emitting element according to the present invention. In this case, a current control element 61 has a structure shown in FIG. 1, and the circumstance of the current control element 61 is kept in a vacuum state by a vacuum chamber 62. And a capacitor 66 is arranged in series between a driving electrode 63 and a common electrode 64 in order to prevent short-circuit between the driving electrode 63 and the common electrode 64. A bias voltage Vb is applied to an electron capturing electrode 67 opposite to the driving electrode 63 and the common electrode 64.

In case of making the voltage V1 to be applied to a signal voltage source 65 be −400 V, the capacity of the capacitor 66 be 500 pF, the bias voltage be 0 V, the width of a slit formed by the driving electrode 63 and the common electrode 64 be 10 μm, and the degree of vacuum inside the vacuum chamber 62 be 1×10⁻³ Pa, the current I₁ flowing through the driving electrode 63 becomes 2.0 A and the density of a collector current Ic taken from the electron capturing electrode 67 becomes 1.2 A/cm². As a result, according to an electron-emitting element of the present invention, a higher current density is obtained at a lower voltage and a lower degree of vacuum in comparison with a conventional electron-emitting element, and as a result an excellent straight advancing ability is displayed. As shown in FIG. 7B, the collector current Ic becomes larger as the bias voltage Vb becomes higher.

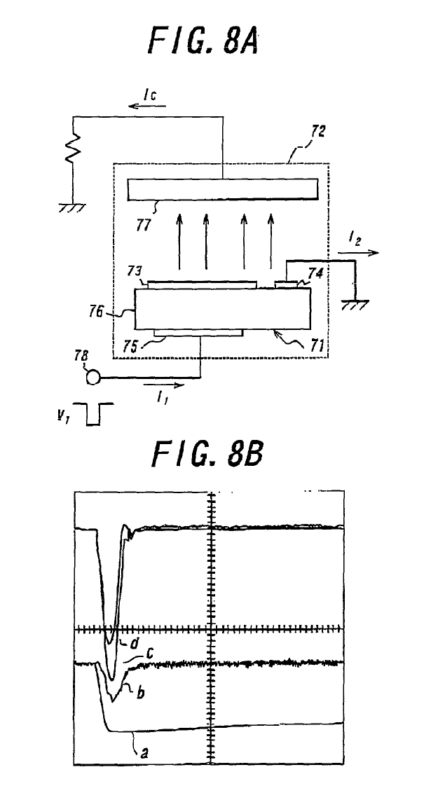

FIG. 8 is a diagram for explaining the operation of the other electron-emitting element according to the present invention. In this case, a current control element 71 has a structure shown in FIG. 2, and the circumstance of the current control element 71 is kept in a vacuum state by a vacuum chamber 72. And an electric field applying portion 76 between a driving electrode 73 and a driving terminal electrode 75 acts as a capacitor in order to prevent short-circuit between the driving electrode 73 and the common electrode 74. An electron capturing electrode, 77 is opposite to the driving electrode 73 and the common electrode 74.

In case of making the voltage V1 to be applied to a signal voltage source 78 be −400 V, the capacity of the electric field applying portion 76 acting as a capacitor be 530 pF, the width of a slit formed by the driving electrode 73 and the common electrode 74 be 10 μm, and the degree of vacuum inside the vacuum chamber 72 be 1×10⁻³ Pa, the circuit I₁ flowing through the driving terminal electrode 75 becomes 2.0 A and the density of a collector current Ic taken from the electron capturing electrode 77 becomes 1.2 A/cm². As a result, according to another electron emitting element of the present invention a higher current density is obtained at a lower voltage and a lower degree of vacuum in comparison with a conventional electron-emitting element, and as a result an excellent straight advancing ability is displayed. The waveforms of the voltage V₁, and the currents Ic, I₁ and I₂ are respectively shown by curves a to d in FIG. 8B.

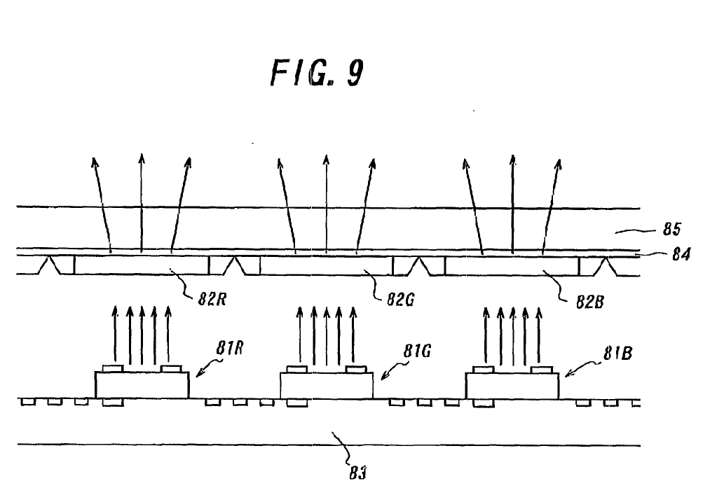

FIG. 9 is a diagram showing an embodiment of the FED according to the present invention. This FED comprises a plurality of electron-emitting elements 81R, 81G and 81B arranged in two dimensions, and a red phosphor 82R, green phosphor 82G and blue phosphor 82B being arranged at a certain space to these electron-emitting elements 81R, 81G and 81B, respectively.

In this embodiment, the electric-emitting elements 81R, 81G, and 81B are formed on a substrate 83, and the red phosphor 82R, green phosphor 82G and blue phosphor 82B are formed through the electron capturing electrode 84 on a glass substrate 85. The electron-emitting elements 81R, 81G and 81B each have a structure shown in FIG. 2, but may have any of the structures shown in FIGS. 1 and 3 to 6.

According to this embodiment, since the electron-emitting elements 81R, 81G and 81B are excellent in straight advancing ability, the crosstalk is smaller compared with a case of having conventional electron-emitting elements and the pitch between the phosphors 82R, 82G and 82B can be narrower, and it is not necessary to provide a grid in order to prevent electrons from striking on adjacent phosphors 82R, 82G and 82B. As a result, the FED of this embodiment is preferable from the viewpoint of downsizing and cost reduction. Since it can emit electrons even if the degree of vacuum is comparatively low, it is not necessary to leave a margin for a lowering of vacuum by making the vacuum space large in advance and thus restrictions against making the FED thin-sized are reduced.

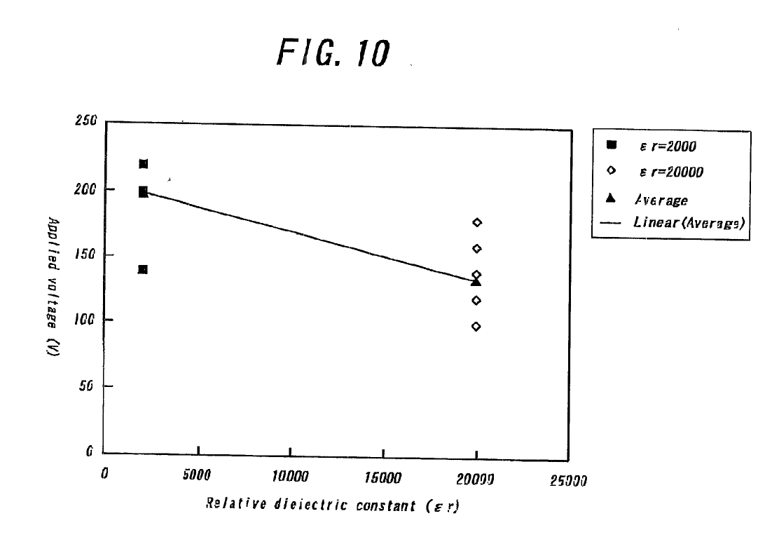

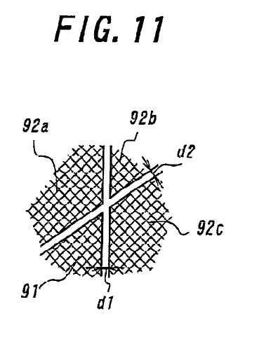

FIG. 10 is a diagram showing the relation between the relative dielectric constant of an electron-emitting element according to the present invention and an applied voltage to it, and FIG. 11 is a diagram for explaining it. The characteristic of FIG. 10 shows the relation between the relative dielectric constant of an electric field applying portion and the applied voltage required for emission of elections in case that each of the widths d1 and d2 of slits formed by a driving electrode 91 and common electrodes 92a to 92c as shown in FIG. 11 is 10 μm.

As shown in FIG. 10, in case of driving an electron-emitting element by means of a lower applied voltage compared with the conventional electron-emitting element, it is known that the relative dielectric constant is preferably not less than 1000.

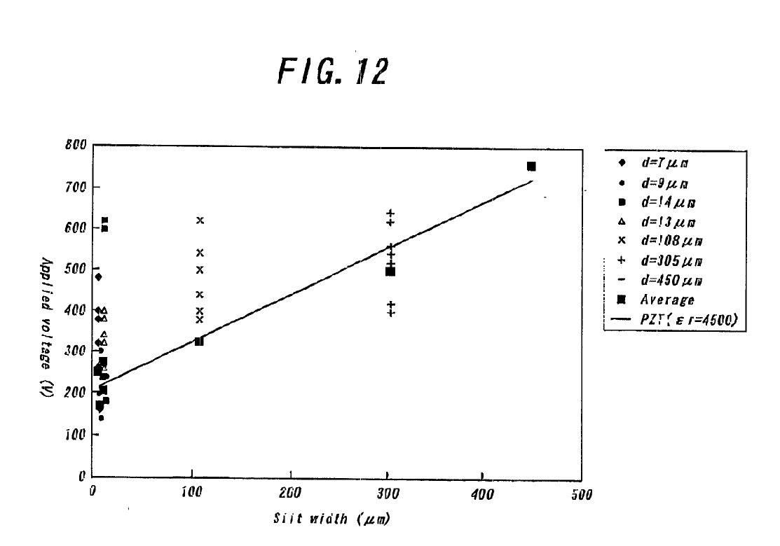

FIG. 12 is a diagram showing the relation between the width of a alit of the electron-emitting element according to the present invention and an applied voltage to it. From FIG. 12 it is known that it is necessary to make the slit width be not more than 500 μm in order to make a electron emission phenomenon occur. In order to drive the electron-emitting element according to the present invention by means of a driver IC to be used in a plasma display, a fluorescent display tube or a liquid crystal display which are on the market, it is necessary to make the slit width be not more than 20 μm.

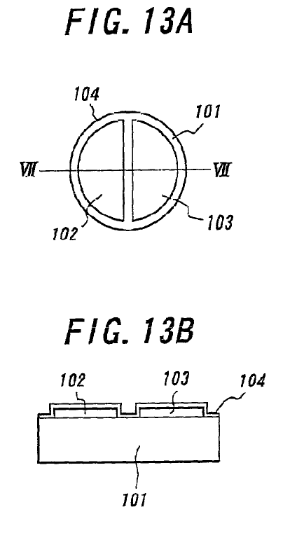

FIG. 13A is a top view of a seventh embodiment of the electron-emitting element according to the present invention, and FIG. 13B is a sectional view taken along a line VII-VII of it. In this embodiment, a driving electrode 102 and a common electrode 103 each being in the shape of a semicircle are formed on one side of an electric field applying portion 101, and a conductive coating portion 104 is applied to the driving electrode 102, the common electrode 103 and a slit formed by them.

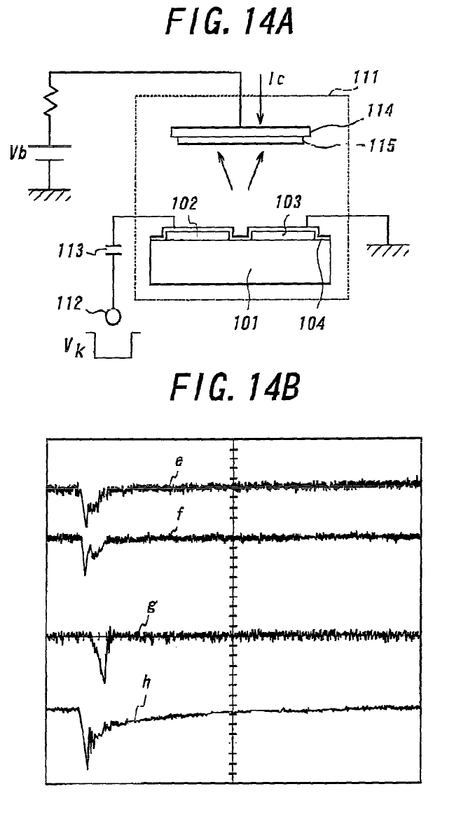

The operation of the electron-emitting element having a structure shown in FIG. 13 is described with reference to FIG. 14. In this case, the periphery of the electron-emitting element is kept in a vacuum state by a vacuum chamber 111. A capacitor 113 is arranged in series between the driving electrode 102 and the voltage signal source 112 in order to prevent short-circuit between the driving electrode 102 and the common electrode 103. An electron capturing electrode 114 opposite to the driving electrode 102 and the common electrode 103 has a phosphor 115 provided on it and has a bias voltage Vb applied to it.

The driving electrode 102 and the common electrode 103 each are an Au film of 3 μm in thickness, and a conductive coating portion 104 made of carbon (of 3 μm in film thickness) is applied to these driving electrode 102 and common electrode 103 and the slit part therebetween. In case of making a voltage Vk to be applied to the signal voltage source 112 be 25 V, making the capacity of the capacitor 113 be 5 nF, making a bias voltage Vb be 300 V, forming the electric field applying portion 101 out of an electrostrictive material of 14,000 in relative dielectric constant, making the width of a slit formed by the driving electrode 102 and the common electrode 103 be 10 μm, and making the degree of vacuum inside the vacuum chamber 111 be 1×10⁻³ Pa, a current Ic flowing through the electrode capturing electrode 114 becomes 0.1 A and a current of about 40% of a current I₁ (0.25 A) flowing through the driving electrode 102 is taken as an electron current, and a voltage Vs between the driving electrode 102 and the common electrode 103, namely, a voltage required for emission of electrons becomes 23.8 V. As a result, according to the electron-emitting element shown in FIG. 13, a voltage necessary for emission of electrons can be remarkably lowered. And the conductive coating portion 104 reduces remarkably the possibility that the driving electrode 102 and the common electrode 103 are damaged by collision of electrons or ions, or by generation of heat. The waveforms of the current I₁ flowing through the driving electrode 102, the currents I₂, Ic flowing through the common electrode 103, and the voltage Vs are respectively shown by curves c to h in FIG. 14B.

The conductive coating 104 is composed of carbon or a conductor with resistance to a high-temperature oxidizing atmosphere, for example, a single metal, an alloy, a mixture of an insulating ceramic and a single metal, a mixture of an insulating ceramic and an alloy or the like, and is preferably composed of a high-melting point precious metal such as platinum, palladium, rhodium, molybdenum or the like, or a material having such an alloy as silver—palladium, silver—platinum, platinum—palladium or the like, as its main ingredient, or a cermet material of platinum and ceramic. More preferably, it is composed of only platinum or a material having a platinium-based alloy as its main ingredient. And as a material for electrodes, carbon-based or graphite-based materials, for example, a diamond thin film, a diamond-like carbon and a carbon nanotube are also preferably used. A ceramic material added to the electrode material is preferably 5 to 30 vol %. Preferably, the conductive coating portion 104 has the resistance between several kΩ and 100 kΩ, for example, The conductive coating portion 104 is formed by carbon membrane made by vacuum evaporation (for example, the membrane made from “CARBON 5PC” (made by SANYU KOGYO) by vacuum evaporation), rubbed-in carbon (for example, “FW200” (made by Degussa)), or printed carbon

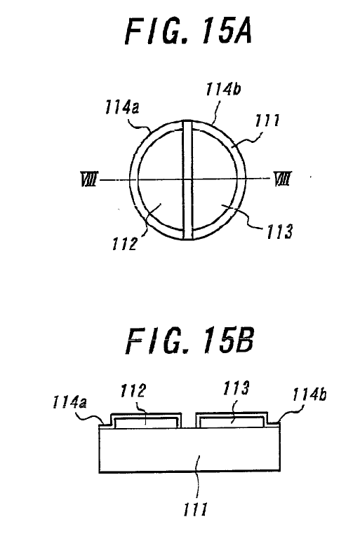

FIG. 15A is a top view of an eighth embodiment according to the present invention, and FIG. 15B is a sectional view of it taken along line VIII-VIII. This embodiment forms a semicircle-shaped driving electrode 112 and a common electrode 113 on one side of an electric field applying portion 111, forms a conductive coating portion 114a on the driving electrode 112, and forms a conductive coating portion 114b being in no contact with the conductive coating portion 114a on the common electrode 113.

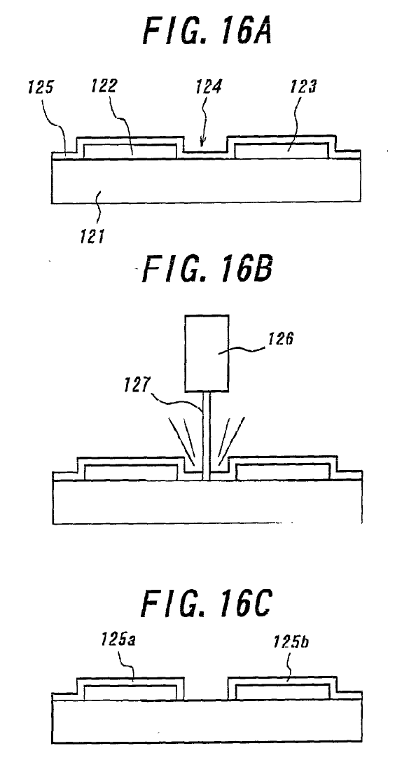

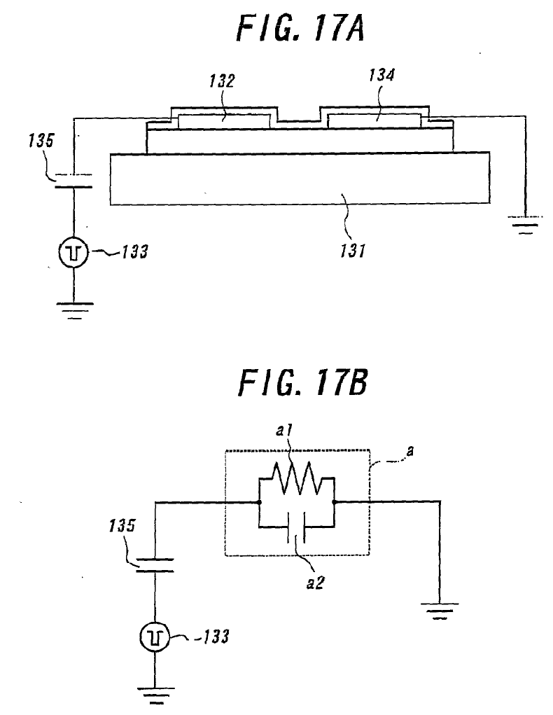

Such an electron-emitting element 15 obtained by forming a driving electrode 122 and a common electrode 123 on one side of an electric field applying portion 121 by means of printing and then forming a coating portion 125 by means of carbon-vapor deposition of a conductive material on the driving electrode 122, the common electrode 123 and a slit 124 formed by these electrodes to FIG. 16A), irradiating the slit 124 with a laser beam 127 from a laser irradiating source 126 (FIG. 16B), and thereby forming a conductive coating portion 125a and a conductive coating portion 125b being in no contact with the conductive coating portion 125a. An electron emitting element of a structure shown in FIG. 16C can be also obtained by forming a driving electrode 122 and a common electrode 123 on one side of an electric field applying portion 121 by means of printing and then forming a conductive coating portion 125a and a conductive coating portion 125b being in no contact with the conductive coating portion 125a by means of printing. And an electron-emitting element of a structure shown in FIG. 16C can be also obtained by applying a thin-film technology such as photolithography.

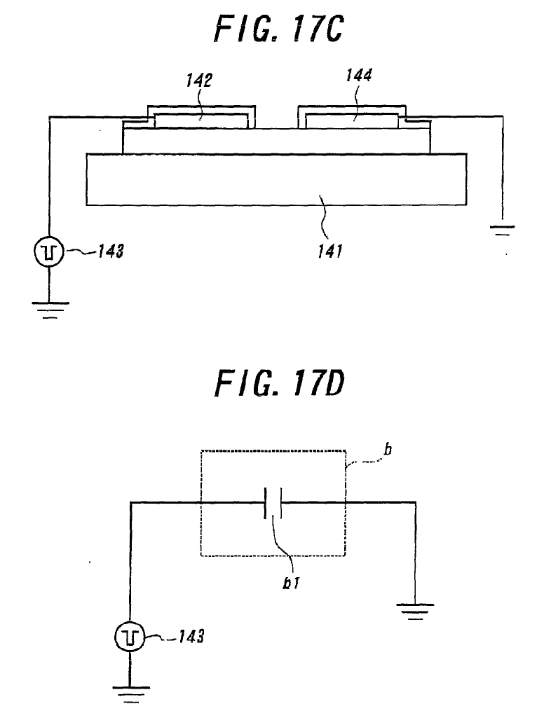

According to the eighth embodiment of an electron-emitting element of the present invention, the possibility of damaging the driving electrode and common electrode due to collision or heat generation of electrons or ions is remarkably reduced thanks to the first conductive coating portion and the second conductive coating portion being in no contact with the first coating portion, and a driving voltage in case of using the electron-emitting element in a driving circuit is greatly reduced. Such a great reduction in the driving voltage is described in detail. In case of arranging an electron-emitting element of said seventh embodiment on a zirconia substrate 131, connecting a driving electrode 132 to a signal voltage source 133 for generating a pulse-shaped signal and grounding a common electrode 134 (FIG. 17A), an equivalent circuit a between the driving electrode 132 and the common electrode 134 has a resistor a1 and a capacitor a2 connected in parallel with this resistor a1 (FIG. 17B). In order to prevent a direct current from flowing through the resistor a1, a capacitor 135 for cutting off a direct current is provided contrary, in case of arranging an electron-emitting element of said eighth embodiment on a zirconia substrate 141, connecting a driving electrode 142 to a signal voltage source 143 for generating a pulse-shaped signal and grounding a common electrode 144 (FIG. 17C), an equivalent circuit b between the driving electrode 142 and the common electrode 144 has a capacitor b1 only (FIG. 17D). Since the equivalent circuit b has no resistor, it becomes unnecessary to provide a capacitor for cutting off a direct current between the signal voltage source 143 and the electron-emitting element. Since the driving voltage is not divided by a capacitor for cutting off a direct current, a driving voltage used in a driving circuit is more greatly reduced in comparison with said seventh embodiment and driving at a high voltage becomes unnecessary, and as a result, the circuit can be made lower in cost.

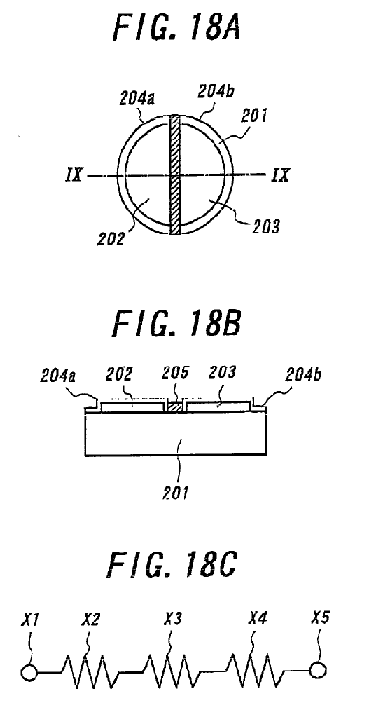

FIG. 18A is a top view of a ninth embodiment of an electron-emitting element according to the present invention, and FIG. 18B is a sectional view of it taken along line IX-IX. This embodiment forms a semicircle-shaped driving electrode 202 and a common electrode 203 on one side of an electric field applying portion 201, forms a conductive coating portion 204a on the driving electrode 202, and forms a conductive coating portion 204b being in no contact with the conductive coating portion 204a on the common electrode 203. And this electron-emitting element forms a high resistance portion 205 which is composed of a material being higher in resistivity than the conductive coating portions 204a and 204b and is in electric contact with the conductive coating portions 204a and 204b in a slit formed by the driving electrode 202 and the common electrode 203.

An equivalent circuit between the driving circuit 202 and the common electrode 203 has, as shown in FIG. 18C, a terminal x1, resistors x2, x3 and x4 and a terminal x5 respectively corresponding to the driving electrode 202, the conductive coating portion 204a, the high resistance portion 205, the conductive coating portion 204b and the common electrode 203. When a voltage is applied to the electron-emitting element, the voltage of the high resistance portion 205 becomes higher than the voltage of the conductive coating portions 204a and 204b, and the degree of concentration of electric field in the high resistance portion, namely, in the slit is improved. As a result, it is possible to emit electrons at a low applied voltage, reduce the power consumption, miniaturize the circuit of the electron-emitting element and attain a cost reduction thanks to omitting high-voltage components.

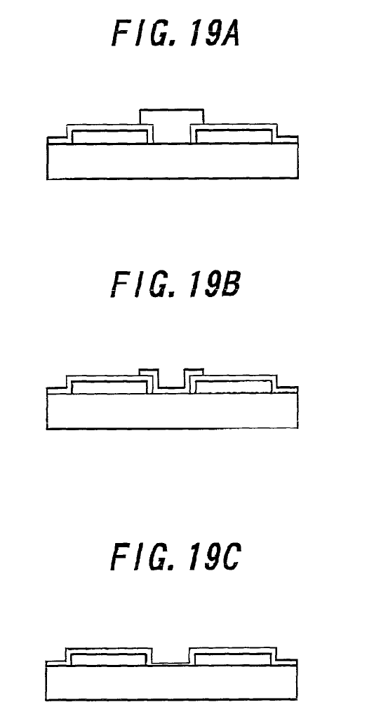

FIG. 19 is a diagram showing a variation example of the electron-emitting element of FIG. 18. In FIGS. 19A and 19B, a high resistance portion which is composed of a material being higher in resistivity than two conductive coating portions being in no contact with each other and is in electric contact with these conductive coating portions is provided in a slit formed by a driving electrode and a common electrode. In FIG. 19C, a high resistance portion which is composed of the same material as two conductive coating portions being in no contact with each other and is thinner in thickness than these conductive coating portions is provided in a slit formed by a driving electrode and a common electrode. Such a high resistance portion can be obtained, for example, by irradiating the conductive coating portion on the slit with a laser and forming a conductive coating portion being thinner in thickness in comparison with the conductive coating portions formed on the driving and common electrodes.

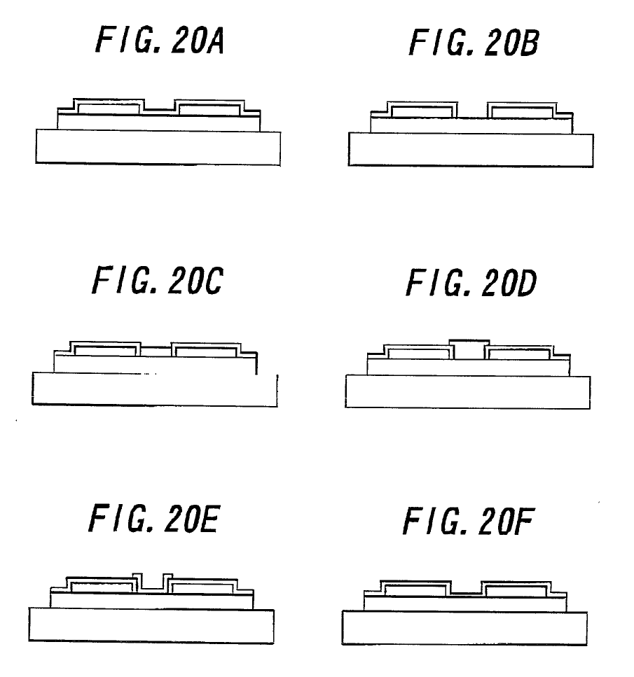

FIG. 20 is a diagram showing a tenth embodiment of an electron-emitting element according to the present invention. This embodiment is an electron-emitting element provided on a zirconium oxide (zirconia) substrate, and on the zirconium oxide substrate there is arranged, for example, an electron-emitting element shown in FIG. 13 (FIG. 20A), an electron-emitting element shown in FIG. 15 (FIG. 20B), an electron-emitting element shown in FIG. 18 (FIG. 20C), an electron-emitting element shown in FIG. 19A (FIG. 20D), an electron-emitting element shown in FIG. 19B (FIG. 20E) or an electron-emitting element shown in FIG. 19C (FIG. 20F). As described already, forming a substrate out of zirconium oxide is preferably from the viewpoint of strength, tenacity and durability.

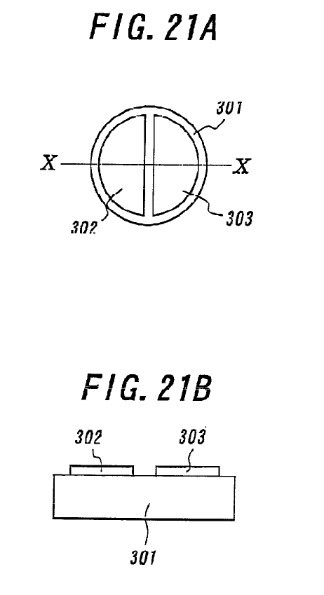

FIG. 21A is a top view of a eleventh embodiment of the electron-emitting element according to the present invention, and FIG. 21B is a sectional view taken along a line X-X of it. In this embodiment, a driving electrode 302 and a common electrode 303 each being in the shape of a semicircle are formed on one side of an electric field applying portion 301.

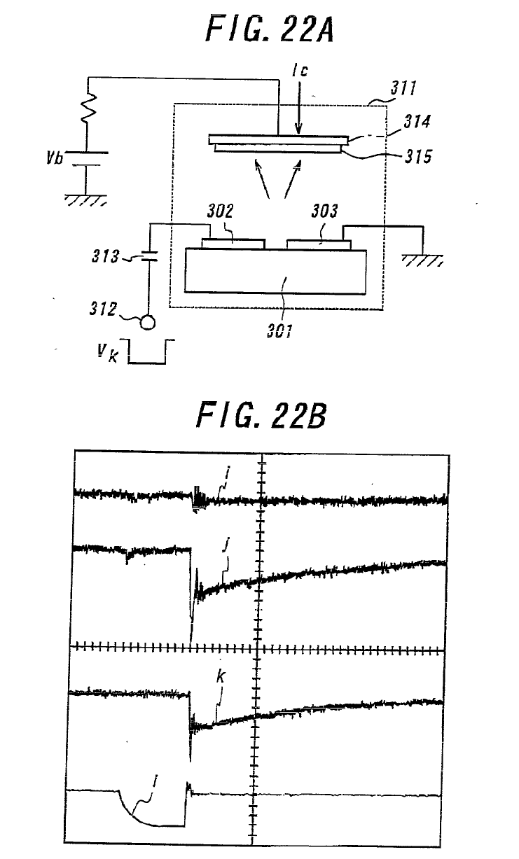

It is described with reference to FIG. 22 that electrons are emitted at a low vacuum of not more than 200 Pa also in case of an electron-emitting element having a structure shown in FIG. 21, namely, in case of having no carbon coating. In this case, the circumstance of the electron-emitting element is kept in a vacuum state by a vacuum chamber 311. A capacitor 313 is arranged in series between the driving electrode 302 and a voltage signal source 312. An electron capturing electrode 314 opposite to the driving electrode 302 and the common electrode 303 has a phosphor 315 provided on it and has a bias voltage Vb applied to it.

A material for each of the driving electrode 302 and the common electrode 303 is Au, and in case of making a voltage Vk to be applied to the signal voltage source 312 be 160 V, making the capacity of the capacitor 313 be 5 nF, making the bias voltage Vb be 300 V, forming the electric field applying portion 301 out of an electrostrictive material of 4,500 in relative dielectric constant, making the width of a slit formed by he driving electrode 302 and the common electrode 303 be 10 μm, and making the degree of vacuum inside the vacuum chamber 311 be 200 Pa or less, a current Ic flowing through the electron capturing electrode 314 becomes 1.2 A and a current of about 60% of a current I₁ (2 A) flowing through the driving electrode 302 is taken as an electron current, and a voltage Vs between the driving electrode 302 and the common electrode 303, namely, a voltage required for emission of electrons becomes 153 V. The waveforms of the currents I₁, I₂ and Ic, and the voltage Vs are respectively shown by curves i to 1 in FIG. 22B.

It is the same also in case of having a carbon coating that a sufficient electron emission can be made at a very low vacuum of not more than 200 Pa as described above.

Since the electron-emitting element according to the present invention can emit electrons at a very low vacuum of not more than 200 Pa, in case of forming an FED, it is possible to make very small a sealed space of the outer circumferential part of a panel, and thus it is possible to realize a narrow-frame panel. And in case of make a large-sized display by arranging a plurality of panels, a joint between panels is made hard to be conspicuous. Further, in a conventional FED the degree of vacuum of a space inside the FED is lowered by gas produced from a phosphor and the like and there is the possibility that the durability of a panel receives a bad influence, but since a display using the electron-emitting element according to the present invention can emit electrons at a very low vacuum of not more than 200 Pa, a bad influence caused by lowering of the degree of vacuum of a space inside the FED is greatly reduced and the durability and reliability of the panel are greatly improved.

The electron-emitting element according to the present invention and the FED using it can be more simplified and made more small-sized in comparison with those of the prior art. Concretely explaining them, first since the degree of vacuum in a space inside an FED can be made low, an enclosure supporting structure facing a pressure difference between the inside and the outside of the outer circumferential sealed part and the like of an FED can be simplified and made small sized.

And since an applied voltage necessary for emitting electrons and a bias voltage to be applied to an electron capturing electrode can be made comparatively low, the FED does not need to be of a pressure-resisting structure and it is possible to make the whole display device small-sized and the panel thin-sized. A bias voltage to be applied to the electron capturing electrode may be 0 V.

And since the electric field applying portion of the electron-emitting element according to the present invention can be formed without the need of a special processing as required in case of forming an electron-emitting element of a Spindt type and furthermore the electrodes and the electric field applying portion can be formed by a thick film printing method, an electron-emitting element according to the present invention and an FED using it can be manufactured in lower cost in comparison with those of the prior art.

Moreover, since an applied voltage necessary for emitting electrons and a bias voltage to be applied to an electron capturing electrode can be made comparatively low, a driving IC being comparatively low in dielectric strength, small-sized and inexpensive can be used and therefore an FED using an electron-emitting element according to the present invention can be manufactured in low cost.

The present invention is not limited to the embodiments described above but can be variously modified and varied in many manners.

For example, the electron-emitting element according to the present invention can be also applied to another application such as backlighting. Since the electron-emitting element according to the present invention can emit a comparatively large amount of electron beam at a comparatively low voltage, it is preferable for forming a small-sized and high-efficiency sterilizer in place of a conventional sterilizer using mainly an ultraviolet ray emission method. And the electron-emitting element according to the present invention can adopt any other electrode structure having an angular part. Further, it can arrange a resistor in series between a second electrode, namely, a common electrode and a direct offset voltage source in order to prevent short-circuit between a driving electrode and a common electrode.

In the sixth embodiment, the case where the electric field applying portions 51a, 51b are formed out of an antiferroelectric material has been described, but it is enough that the electric field applying portions 51a, 51b are formed out of at least one of a piezoelectric materials, an electrostrictive material and an antiferroelectric material. In case of using a piezoelectric material and/or an electrostrictive material, there can be used for example a material having lead zirconate (PZ-based) as its main ingredient, a material having nickel lead niobate as its main ingredient, a material having zinc lead niobate as its main ingredient, a material having manganese lead niobate as its main ingredient, a material having magnesium lead tantalate as its main ingredient, a material having nickel lead tantalate as its main ingredient, a material having antimony lead stannate as its main ingredient, a material having lead titanate as its main ingredient, a material having magnesium lead tungstate as its main ingredient, a material having cobalt lead niobate as its main ingredient, or a composite material containing an optional combination of these materials, and among them a ceramic material containing lead zirconate is most frequently used as a piezoelectric material and/or an electrostrictive material.

In case of using a ceramic material as a piezoelectric material and/or an electrostrictive material, a proper material obtained by properly adding an oxide of lanthanum, barium, niobium, zinc, cerium, cadminium, chromium, cobalt, antimony, iron, yttrium, tantalum, tungsten, nickel, manganese, lithium, strontium, bismuth or the like, or a combination of some of these materials or other compounds to the ceramic material, for example, a material obtained by adding a specific additive to it so as to form a PZT-based material is also preferably used.

Among these piezoelectric materials and/or electrostrictive materials, a material having as its main ingredient a component consisting of magnesium lead niobate, lead zirconate and lead titanate, a material having as its main ingredient a component consisting of nickel lead niobate, magnesium lead niobate, lead zirconate and lead titanate, a material having as its main ingredient a component consisting of magnesium lead niobate, nickel lead tantalate, lead zirconate and lead titanate, a material having as its main ingredient a component consisting of magnesium lead tantalate, magnesium lead niobate, lead zirconate and lead titanate, and a material substituting strontium and/or lanthanum for some part of lead in these materials and the like are preferably used, and they are preferable as a material for forming the electric field applying portions 51a, 51b by means of a thick film forming technique such as a screen printing method and the like as described above.

In case of a multiple-component piezoelectric material and/or electrostrictive material, its piezoelectric and/or electrostrictive characteristics vary depending upon the composition of their components, and a three-component material of magnesium lead niobate—lead zirconate—lead titanate, or a four-component material of magnesium lead niobate—nickel lead tantalate—lead zirconate—lead titanate or a four-component material of magnesium lead tantalate—magnesium lead niobate—lead zirconate—lead titanate preferably has the composition in the vicinity of the phase boundary of pseudo-cubic system-tetragonal system-rhombohedral system, and particularly the composition of magnesium lead niobate of 15 to 50 mol %, lead zirconate of 10 to 45 mol % and lead titanate of 30 to 45 mol %, the composition of magnesium lead niobate of 15 to 50 mol %, nickel lead tantalate of 10 to 40 mol %, lead zirconate of 10 to 45 mol % and lead titanate of 30 to 45 mol %, and the composition of magnesium lead niobate of 15 to 50 mol %, magnesium lead tantalate of 10 to 40 mol %, lead zirconate of 10 to 45 mol % and lead titanate of 30 to 45 mol % are preferably adopted from the reason that they have a high piezoelectricity constant and a high electro-mechanical coupling coefficient.

In the ninth embodiment, the high resistance portion may be of a material having a conductive material sparsely distributed in it, a material changed in structure by locally destroying, deforming or changing in property a conductive material in it, a material changed in structure or microcracked by processing a conductive coating portion by means of application of a high voltage or the like and by locally destroying, deforming or changing in property a conductive material in it, a material whose resistance value is made high by a fact that the slit expands due to a piezoelectric effect only when applying an electric field, or a material whose resistance value is made high by a fact that it is microcracked due to a piezoelectric effect. In case of using as the high resistance portion a material whose resistance value is made high by a fact that the slit expands due to a piezoelectric effect only when applying an electric field, there is an advantage of making it possible to omit a preprocess at the time of manufacturing an electron-emitting element.

1. An electron-emitting element comprising:
an electric field applying portion composed of a dielectric;
a first electrode formed on one surface of this electric field applying portion; and
a second electrode formed on said one surface of the electric field applying portion, and forming a slit in cooperation with said first electrode.

2. An electron-emitting element according to claim 1, further comprising a third electrode arranged at a certain space to said first and second electrodes, wherein space between said first and second electrodes and said third electrode is vacuum.

3. An electron-emitting element according to claim 2, further comprising:
a voltage source for applying a direct offset voltage to said third electrode; and
a resistor arranged in series between this voltage source and said third electrode.

4. An electron-emitting element according to claim 1, wherein a conductive coating portion is applied to said first electrode, said second electrode and said slit.

5. An electron-emitting element according to claim 4, further comprising a third electrode arranged at a certain space to said first and second electrodes, wherein space between said first and second electrodes and said third electrode is vacuum.

6. An electron-emitting element according to claim 5, further comprising:
a voltage source for applying a direct offset voltage to said third electrode; and
a resistor arranged in series between this voltage source and said third electrode.

7. An electron-emitting element according to claim 1, wherein further comprising a first conductive coating portion provided on said first electrode; and
a second conductive coating portion provided on said second electrode;
wherein, there is non-contact condition between said first conductive coating portion and said second conductive coating portion.

8. An electron-emitting element according to claim 7, wherein a portion with a high resistance being provided on said slit, said portion having a higher resistance than those of said first and said second conducting coating portions and being in contact with said first and said second conducting coating portions electrically.

9. An electron-emitting element according to claim 7, further comprising a third electrode arranged at a certain space to said first and second electrodes, wherein space between said first and second electrodes and said third electrode is vacuum.

10. An electron-emitting element according to claim 9, further comprising:
a voltage source for applying a direct offset voltage to said third electrode; and
a resistor arranged in series between this voltage source and said third electrode.

11. An electron-emitting element according to claim 1, wherein a pulse voltage is applied to said first electrode and a direct offset voltage is applied to said second electrode.

12. An electron-emitting element according to claim 1, further comprising a capacitor arranged in series between said first electrode and said voltage source.

13. An electron-emitting element according to claim 1, further comprising a fourth electrode formed on the other surface of said electric field applying portion and facing to said first electrode.

14. An electron-emitting element according to claim 13, wherein a pulse voltage is applied to said fourth electrode and a direct offset voltage is applied to said second electrode.

15. An electron-emitting element according to claim 1, further comprising a resistor arranged in series between said second electrode and a direct offset voltage source.

16. An electron-emitting element according to claim 1, wherein said electric field applying portion has the relative dielectric not less than 1000.

17. An electron-emitting element according to claim 1, wherein said slit has the width not more than 500 μm.

18. An electron-emitting element according to claim 1, wherein at least one of said first electrode and said second electrode has an angular part with an acute angle.

19. An electron-emitting element according to claim 1, wherein said first electrode and said second electrode each have carbon nanotubes.

20. An electron-emitting element comprising:
an electric field applying portion composed of it least one of a piezoelectric material, an electrostrictive material and an antiferroelectric material;
a first electrode formed on one surface of this electric field applying portion; and
a second electrode formed an said one surface of the electric field applying portion, and forming a slit in cooperation with said first electrode.

21. An electron-emitting element according to claim 20, further comprising a third electrode arranged at a certain space to said first and second electrodes, wherein space between aid first and second electrodes and said third electrode is vacuum.

22. An electron-emitting, element according to claim 21, wherein said electric field applying portion also acts an actuator and controls the quantity of emitted electrons by the displacement motion of said electric field applying portion.

23. An electron-emitting element according to claim 21, further comprising:
a voltage source for applying a direct offset voltage to said third electrode; and
a resistor arranged in series between this voltage source and said third electrode.

24. An electron-emitting element according to claim 20, wherein n conductive coating portion is applied to said first electrode, said second electrode and said slit.

25. An electron-emitting element according to claim 24, further comprising a third electrode arranged at a certain space to said first and second electrodes, wherein space between said first and second electrodes and said third electrode is vacuum.

26. An electron-emitting element according to claim 25, wherein said electric field applying portion also acts an actuator and controls the quantity of emitted electrons by the displacement motion of said electric field applying portion.

27. An electron-emitting element according to claim 25, further comprising:
a voltage source for applying a direct offset voltage to said third electrode; and
a resistor arranged in series between this voltage source and said third electrode.

28. An electron-emitting element according to claim 20, wherein further comprising a first conductive coating portion provided on said first electrode; and
a second conductive coating portion provided on said second electrode;
wherein, there is non-contact condition between said first conductive coating portion and said second conductive coating portion.

29. An electron-emitting element according to claim 28, wherein a portion with a high resistance being provided on said slit, said portion having a higher resistance than those of said first and said second conducting coating portions and being in contact with said first and said second conductive coating portions electrically.

30. An electron-emitting element according to claim 28, further comprising a third electrode arranged at a certain space to said first and second electrodes, wherein space between said first and second electrodes and said third electrode is vacuum.

31. An electron-emitting element according to claim 28, wherein said electric field applying portion also acts an actuator and controls the quantity of emitted elections by the displacement motion of said electric field applying portion.

32. An electron-emitting element according to claim 28, further comprising:
a voltage source for applying a direct offset voltage to said third electrode; and
a resistor arranged in series between this voltage source and said third electrode.

33. An election-emitting element according to claim 20, wherein a pulse voltage is applied to said first electrode and a direct offset voltage is applied to said second electrode.

34. An electron-emitting element according to claim 20, further comprising a capacitor arranged in series between said first electrode and said voltage source.

35. An electron-emitting element according to claim 20, further comprising a fourth electrode formed on the other surface of said electric field applying portion and facing to said first electrode.

36. An electron-emitting element according to claim 35, wherein a pulse voltage is applied to said fourth electrode and a direct offset voltage is applied to said second electrode.

37. An electron-emitting element according to claim 20, further comprising a resistor arranged in series between said second electrode and a direct offset voltage source.

38. An electron-emitting element according to claim 20, wherein said electric field applying portion has the relative dielectric constant not less than 1000.

39. An electron-emitting element according to claim 20, wherein said slit has the width not more than 500 μm.

40. An electron-emitting element according to claim 20, wherein at least one of said first electrode and said second electrode has an angular part with an acute angle.

41. An electron-emitting element according to claim 20, wherein said first electrode and said second electrode each have carbon nanotubes.

42. A field emission display comprising:
a plurality of electron-emitting elements arranged in two dimensions; and
a plurality of phosphors each being arranged with a certain space to each of these electron-emitting elements,
each of said electron-emitting elements having:
an electric field applying portion made of a dielectric;
a first electrode formed on one solace of this electric field applying portion; and
a second electrode formed on said one surface of the electric field applying portion, and forming a slit in cooperation with said first electrode.

43. A field emission display according to claim 42, wherein a third electrode is arranged on the opposite surface to a surface of each of said phosphors facing said first and second electrodes, and the space between said first and second electrodes and said phosphor is vacuum.

44. A field emission display according to claim 42, wherein each of said electron-emitting elements comprises:
a voltage source for applying a direct offset voltage to said third electrode; and
a resistor arranged in series between this voltage source and said third electrode.

45. A field emission display according to claim 42, wherein a conductive coating portion is applied to said first electrode, said second electrode and said slit.

46. A field omission display according to claim 45, wherein a third electrode is arranged on the opposite surface to a surface of each of said phosphors facing said first and second electrodes, and the space between said first and second electrodes and said phosphor is vacuum.

47. A field emission display according to claim 42, wherein each of said electron-emitting elements comprises:
a voltage source for applying a direct offset voltage to said third electrode; and
a resistor arranged in series between this voltage source and said third electrode.

48. A field emission display according to claim 42, wherein each of said electron-emitting elements comprises:
a first conductive coating portion provided on said first electrode; and
a second conductive coating portion provided on said second electrode;
wherein, there is non-contact condition between said first conductive coating portion and said second conductive coating portion.

49. A field emission display according to claim 42, wherein each of said electron-emitting elements comprises:
a portion with a high resistance provided on said slit, said portion having a higher resistance than those of said first and said second conducting coating portions and being in contact with said first and said second conducting coating portions electrically.

50. A field emission display according to claim 48, wherein a third electrode is arranged on the opposite surface to a surface of each of said phosphors facing said first and second electrodes, and the space between said first and second electrodes and said phosphor is vacuum.

51. A field emission display according to claim 48, wherein each of said electron-emitting elements comprises:
a voltage source for applying a direct offset voltage to said third electrode; and
a resistor arranged in series between this voltage source and said third electrode.

52. A field emission display according to claim 42, wherein a pulse voltage is applied to said first electrode and a direct offset voltage is applied to said second electrode.

53. A field emission display according to claim 42, wherein each of said electron-emitting elements further comprises a capacitor arranged in series between said first electrode and said voltage signal source.

54. A field emission display according to claim 42, wherein each of said electron-emitting elements further comprises a fourth electrode being formed on the other surface of said electric field applying portion and opposite to said first electrode.

55. A field emission display according to claim 54, wherein a pulse voltage is applied to said fourth electrode and a direct offset voltage is applied to said second electrode.

56. A field emission display according to claim 42, wherein each of said electron-emitting elements further comprises a resistor arranged in series between said second electrode and said direct offset voltage source.

57. A field emission display according to claim 42, wherein said electric field applying portion has the relative dielectric constant not less than 1000.

58. A field emission display according to claim 42, wherein said slit has the width not more than 500 μm.

59. A field emission display according to claim 42, wherein at least one of said first electrode and said second electrode has an angular angle part with an acute angle.

60. A field emission display according to claim 42, wherein said first electrode and said second electrode each have carbon nanotubes.

61. A field emission display according to claim 42, further comprising a substrate having a plurality of electron-emitting elements arranged in two dimensions and formed into one body with each other.

62. A field emission display comprising:
a plurality of electron-emitting elements arranged in two dimensions; and
a plurality of phosphors each being arranged with a certain space to each of these electron-emitting elements,
each of said electron emitting elements having:
an electric field applying portion composed of at least one of a piezoelectric material, an electrostrictive material and an antiferroelectric material;
a first electrode formed on one surface of this electric field applying portion; and
a second electrode formed on said one surface of the electric field applying portion, and forming a slit in cooperation with said first electrode.

63. A field emission display according to clam 62, wherein a third electrode is arranged on the opposite surface to a surface of each of said phosphors facing said first and second electrodes, and the space between said first and second electrodes and said phosphor is vacuum.

64. A field emission display according to claim 62, wherein said electric field applying portion also acts as an actuator and controls the quantity of emitted electrons by the displacement motion of said electric field applying portion.

65. A field emission display according to claim 62, wherein each of said electron-emitting elements comprises:
a voltage source for applying a direct offset voltage to said third electrode; and
a resistor arranged in series between this voltage source and said third electrode.

66. A field emission display according to claim 62, wherein a carbon coating is applied to said first electrode, said second electrode and said slit.

67. A field emission display according to claim 66, wherein a third electrode is arranged on the opposite surface to a surface of each of said phosphors facing said first and second electrodes, and the space between said first and second electrodes and said phosphor is vacuum.

68. A field emission display according to claim 66, wherein said electric field applying portion also acts as an actuator and controls the quantity of emitted electrons by the displacement motion of said electric field applying portion.

69. A field emission display according to claim 66, wherein each of said electron-emitting elements comprises:
a voltage source for applying a direct offset voltage to said third electrode; and
a resistor arranged in series between this voltage source and said third electrode.

70. A field emission display according to claim 62, wherein each of said electron-emitting elements comprises:
a first conductive coating portion provided on said first electrode; and
a second conductive coating portion provided on said second electrode;
wherein, there is non-contact condition between said first conductive coating portion and said second conductive coating portion.

71. A field emission display according to claim 70, wherein each of said electron-emitting elements comprises:
a portion with a high resistance provided on said slit, said portion having a higher resistance than those of said first and said second conducting coating portions and being in contact with said first and said second conducting coating portions electrically.

72. A field emission display according to claim 70, wherein a third electrode is arranged on the opposite surface to a surface of each of said phosphors facing said first and second electrodes, and the space between said first and second electrodes and said phosphor is vacuum.

73. A field emission display according to claim 70, wherein said electric field applying portion also acts as an actuator and controls the quantity of emitted electrons by the displacement motion of said electric field applying portion.

74. A field emission display according to claim 70, wherein each of said electron-emitting elements comprises:
a voltage source for applying a direct offset voltage to said third electrode; and
a resistor arranged in series between this voltage source and said third electrode.

75. A field emission display according to claim 62, wherein a pulse voltage is applied to said first electrode and a direct offset voltage is applied to said second electrode.

76. A field emission display according to claim 62, wherein each of said electron emitting elements further comprises a capacitor arranged in series between said first electrode and said voltage signal source.

77. A field emission display according to claim 62, wherein each of said electron-emitting elements further comprises a fourth electrode being formed on the other surface of said electric field applying portion and opposite to said first electrode.

78. A field emission display according to claim 77, wherein a pulse voltage is applied to said fourth electrode and a direct offset voltage is applied to said second electrode.

79. A field emission display according to claim 62, wherein each of said electron-emitting elements further comprises a resistor arranged in series between said second electrode and said direct offset voltage source.

80. A field emission display according to claim 62, wherein said electric field applying portion has the relative dielectric constant not less than 1000.

81. A field emission display according to claim 62, wherein said slit has the width not more than 500 μm.

82. A field emission display according to claim 62, wherein at least one of said first electrode and said second electrode has an angular part with an acute angle.

83. A field emission display according to claim 62, wherein said first electrode and said second electrode each have carbon nanotubes.

84. A field emission display according to claim 62, further comprising a substrate having a plurality of electron-emitting elements arranged in two dimensions and formed into one body with each other.
